(19) United States
(12) Patent Application Publication
(10) Pub. No.: US 2014/0118831 A1
(43) Pub. Date: May 1, 2014

(54) LIGHT DIFFUSER AND METHOD OF MANUFACTURING THE SAME

(71) Applicant: PANASONIC CORPORATION, Osaka (JP)

(72) Inventors: YOSUKE MIZUYAMA, Newton, MA (US); RICCARDO LETO, Arlington, MA (US); NATHAN HARRISON, Cambridge, MA (US)

(73) Assignee: PANASONIC CORPORATION, Osaka (JP)

(21) Appl. No.: 13/666,180

(22) Filed: Nov. 1, 2012

(51) Int. Cl. G02B 5/02; B44C 1/22; G02B 27/09

(52) U.S. Cl. 359/599; 216/26

(57) ABSTRACT

A light diffuser including a transparent substrate having a top surface and a bottom surface. The top surface having formed thereon a plurality of tilted plane portions including a first tilted plane portion and a second tilted plane portion. The first tilted plane portion being tilted in a first direction and the second tilted plane portion being tilted in a second direction. The first direction of the first tilted plane portion being different from the second direction of the second tilted plane portion.

### TECHNICAL FIELD

The technical field relates to a light diffuser and a method of manufacturing the same and, more particularly, to a light diffuser having a specifically designed exit surface to control the refracted light and a method of manufacturing the same. Such light diffusers can be used in many different applications including, for example, laser projectors.

### BACKGROUND

Laser or light projectors are one of the recent popular trends in consumer electronics. Although the optics provide uniform illumination, there is still a need to homogenize some non-uniformity that appears on the spatial light modulator. Laser diodes may have properties such as divergence angle that are not uniform among production runs. In this case, products may not work as designed. A laser or light diffuser can alleviate these problems by randomizing the output of the light source, thereby smoothing the luminance profile. There are several types of laser or light diffusers which are categorized into diffractive and refractive diffusers. Diffractive diffusers are suited for wide angle diffusion but they are often difficult to handle with diffraction orders (especially zero order) to get uniform illumination. On the other hand, refractive diffusers are much easier to design as they essentially generate no diffraction. Different categories of refractive light diffusers include point-to-point, point-to-line and point-to-area type diffusers.

FIG. 11A depicts a exit surface view of a conventional light diffuser disclosed in U.S. Pat. No. 7,813,054, hereinafter referred to as “prior art diffuser”. The top surface of the prior art diffuser contains saddle shaped structures as shown in FIG. 11B.

Drawbacks of such a prior art diffuser include the relatively large height of the saddle shaped structures which fall in the range of 10-20 μm and the difficulty of manufacturing by lithography. Moreover, such a prior art diffuser employing the saddle-shaped structure is not able to shape the output intensity profile and can only shape the beam pattern in specific, limited circumstances.

### SUMMARY

One of the objects according to the various embodiments described herein is to provide highly efficient and flexible refractive light diffusers which are not only able to arbitrarily shape the output beam pattern, but also shape the output intensity profile.

Another object is to provide light diffusers having a shallow sag preferably no greater than 3 μm.

A further object of the various embodiments is to provide light diffusers which can be manufactured at a relatively low cost implementing grayscale lithography fabrication.

In a first aspect, a light diffuser is provided to include a transparent substrate having a top surface and a bottom surface, the bottom surface of the transparent substrate having a substantially flat shape, the top surface of the transparent substrate having formed thereon a plurality of tilted plane portions, the plurality of tilted plane portions including a first tilted plane portion and a second tilted plane portion, the first tilted plane portion being tilted in a first direction with a first tilt angle with respect to the bottom surface of the transparent substrate, the second titled plane portion being tilted in a second direction with a second tilt angle with respect to the bottom surface of the transparent substrate, and the first direction of the first tilted plane portion being different from the second direction of the second tilted plane portion.

In a second aspect, a refractive light diffuser is provided for outputting a predetermined beam shape having a predetermined intensity profile onto a target plane. The refractive light diffuser includes a transparent substrate having a first surface and a second surface, the first surface of the transparent substrate having a substantially flat shape configured to receive light emitted from a light source, the second surface of the transparent substrate being configured to output the predetermined beam shape having the predetermined intensity onto the target plane, a plurality of circular shaped micro-elements formed on the second surface of the transparent substrate, the circular shaped micro-elements each having a tilted plane portion, and the tilted plane portions of the plurality of circular shaped micro-elements having different sizes and different angles of tilt.

In a third aspect, a method of manufacturing a light diffuser is provided. The manufacturing method including forming a photosensitive resist on a top surface of a transparent substrate, exposing the photosensitive resist to an exposing light passing through a grayscale mask, forming a resist pattern by removing a part of the photosensitive resist, and forming a top surface of the transparent substrate by etching the resist pattern and the transparent substrate, wherein the top surface of the transparent substrate has formed thereon a plurality of tilted plane portions, the plurality of tilted plane portions including a first tilted plane portion and a second tilted plane portion, the first tilted plane portion being tilted in a first direction with a first tilt angle with respect to a bottom surface of the transparent substrate, the second titled plane portion being titled in a second direction with a second tilt angle with respect to the bottom surface of the transparent substrate, and the first direction of the first tilted plane portion being different from the second direction of the second tilted plane portion.

The aforementioned objects, features and advantages will become apparent from the following detailed description of the various embodiments taken together with the accompanying drawings.

### BRIEF DESCRIPTION OF DRAWINGS

FIG. 1A is a top view of a light diffuser according to an exemplary embodiment and FIG. 1B is a cross-sectional view along line 1B-1B of the light diffuser illustrated in FIG. 1A;

FIG. 2 is an exemplary illustration of a design geometry for tilted planes of the light diffuser shown in FIG. 1B;

FIGS. 3A-3D are exemplary target beam shapes of various light diffusers according to the present embodiments;

FIGS. 4A-4C are illustrations of pixel positioning on the surface of an exemplary light diffuser according to the present embodiments;

FIGS. 5A-5C are illustrations of positioning points on the target plane;

FIGS. 6A-6B are illustrations of a computation of a ray angle;

FIG. 7A depicts a surface profile of an exemplary light diffuser according to the present embodiments and FIG. 7B depicts a surface profile of the prior art diffuser;

FIG. 8 is a graph showing an output beam of an exemplary light diffuser according to the present embodiments and showing an output beam of the prior art diffuser;

FIG. 9 is an illustration of an exemplary method for manufacturing the light diffuser shown in FIG. 1B;

FIG. 10A depicts a pre-Fresnelization state of a light diffuser and FIG. 10B depicts a post-Fresnelization state of the light diffuser; and

FIG. 11A is top exit surface view of the prior art diffuser and FIG. 11B depicts a saddle shaped structure of the prior art diffuser.

### DETAILED DESCRIPTION OF THE PREFERRED EMBODIMENTS

It should be understood that the detailed description and specific examples, while indicating preferred embodiments, are intended for the purpose of illustration only and are not intended to limit the scope or number of possible embodiments.

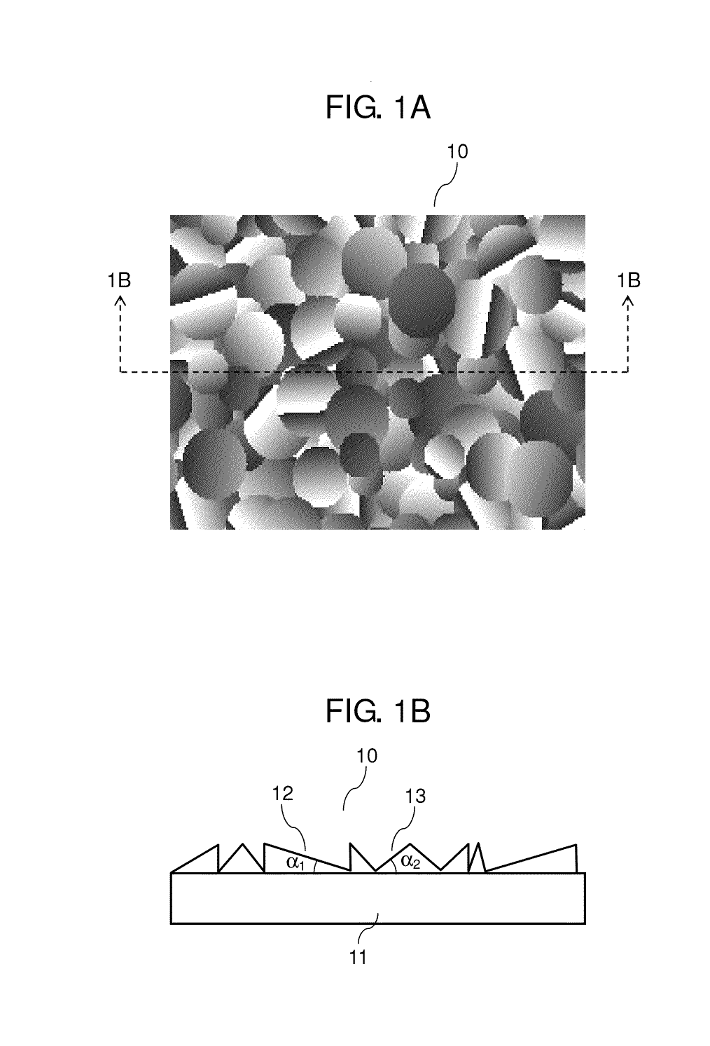

FIG. 1A is a top surface view of the light diffuser 10 according to an exemplary embodiment. FIG 1B is a cross-sectional view along line 1B-1B of the light diffuser illustrated in FIG. 1A.

The light diffuser 10 depicted in FIGS. 1A & 1B is a refractive light diffuser of a point-to-point type having a transparent substrate 11. Light emitted from a light source such as, for example, a laser enters the transparent substrate 11 of the light diffuser 10 from a bottom surface portion which has a substantially flat shape and exits the transparent substrate 11 at a top surface portion having formed thereon a plurality of tilted micro-plane portions. Upon exiting the diffuser 10, light travels to a designated point within a target shape on a target plane which will be described later. A laser is one example of many different light sources which can be used in connection with the exemplary light diffusers. For example, the exemplary light diffusers could be adapted for use with an LED illumination source.

As depicted in FIG. 1A, provided on a top surface of the substrate 11 are an aggregation of randomly pixilated and circular shaped micro planes which are tilted. Specifically, as shown in FIG. 1B, the tilted micro-plane elements include a first tilted plane portion 12 and a second tilted plane portion 13 forming wedge shapes.

The exemplary light diffuser shown in FIG. 1A depicts the tilted micro-planes as having a circular shape when viewed from above the top surface of the light diffuser. However, the shape of such tilted planes are not limited to a circular shape and can be configured in many different shapes such as, for example, an oval shape, a rectangular shape, a pyramidal shape, a trapezoidal shape, a hexagonal shape, . . . etc. Moreover, as illustrated in FIG. 1A, the tilted micro-planes provided on the top surface of the light diffuser 10 are non-uniform in size. That is, the tilted planes may include a combination of small size planes (i.e., lower weight) and large size planes (i.e. higher weight). For example, as shown in FIG. 1B, the first tilted plane portion 12 has a larger size than the second tilted plane portion 13. Furthermore, the micro-planes provided on the top surface of the light diffuser 10 can be tilted in different and non-uniform directions and with different and non-uniform tilt angles. That is, as depicted in FIG. 1B, the first tilted plane portion 12 is tilted in a first direction and at a first tilt angle α1 and the second tilt plane portion 13 is tilted in a second direction and at a second tilt angle α2, the first direction being different than the second direction and the first tilt angle al being different than the second tilt angle α2. Additionally, at least some of the tilted planes can be Fresnelized to provide a constant depth along the light diffuser 10. Additionally, the tilted planes having the circular shape preferably have a diameter within a range of 20-100 μm. The number of tilted planes shown on the top surface of the light diffuser 10 depicted in FIGS. 1A and 1B are provided merely for illustrative purposes and can vary depending on the specific design parameters. For example, the number of tilted planes can vary depending on the dimensions of the tilted planes, the dimensions of the light diffuser, the desired target beam intensity distribution, the desired target shape, input light characteristics, . . . etc.

The light diffuser 10 according to the exemplary embodiment depicted in FIGS. 1A & 1B is a refractive type diffuser which generates a minimal amount of diffraction. However, the minimal diffraction which is generated can be mostly or entirely eliminated by removing pixel periodicity. To remove the pixellation periodicity, circular shaped tilted micro-planes can be selected which are allowed to randomly overlap as depicted in FIG. 1A. By providing such an arrangement, the greatest degree of randomness can be generated and diffraction orders of light can be reduced to a minimum.

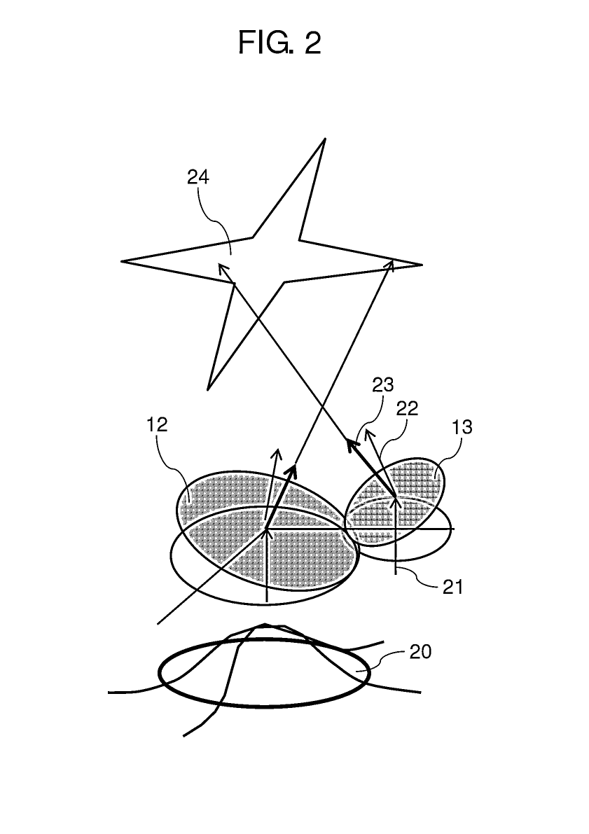

FIG. 2 illustrates an exemplary design geometry of the light diffuser depicted in FIG. 1B using examples of the first tilted plane portion 12 having a large pixel for higher weight and the second tilted plane portion 13 having a small pixel for lower weight. As shown in FIG. 2, light vector 21 enters into the first tilted plane portion 12 resulting in a refracted light vector 23 which has a particular ray angle and which is emitted to a particular target position on a desired target shape 24 having a specific intensity profile. A surface normal vector 22 shown in FIG. 2 can be determined from the ray angle of the refracted light vector 23 and the incidence/divergence angle of the inputted light vector 21. Provided next is a description of an exemplary method for designing a light diffuser in accordance with the aforementioned features with reference to FIGS. 2-6.

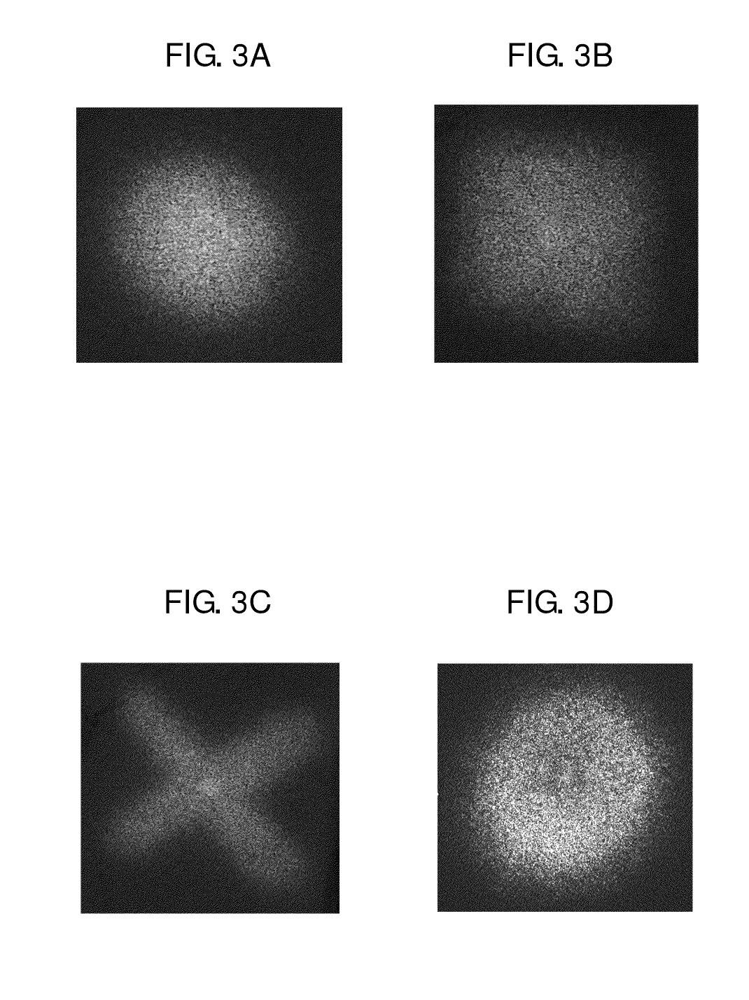

Referring to FIG. 2, a first step is to define the input beam shape, divergence angle, and intensity profile of the light 20 entering into the transparent substrate 11 of the light diffuser 10. The second step is to define the target beam shape 24 and target intensity profile thereof. It is possible to select an arbitrary shape and arbitrary intensity profile as the target beam shape 24 and intensity profile. The star-shape target beam shape 24 depicted in FIG. 2 is provided as one example. That is, it is possible to select a circular shape, a square shape, a cross shape and a donut shape as shown in FIG. 3A, FIG. 3B, FIG. 3C and FIG. 3D, respectively, which depict actual outputs according to exemplary light diffusers. The light diffuser of the present embodiments is not limited to such output shapes and intensities. For example, the output beam shape could be in the form of a corporate logo, personalized message . . . etc., and the target intensity can arbitrarily vary within the target shape. Referring to FIG. 3D, an example is provided of a donut shape in which the output beam intensity varies at different positions of the target shape. That is, the intensity is greater at the perimeter than at the center of the donut shape.

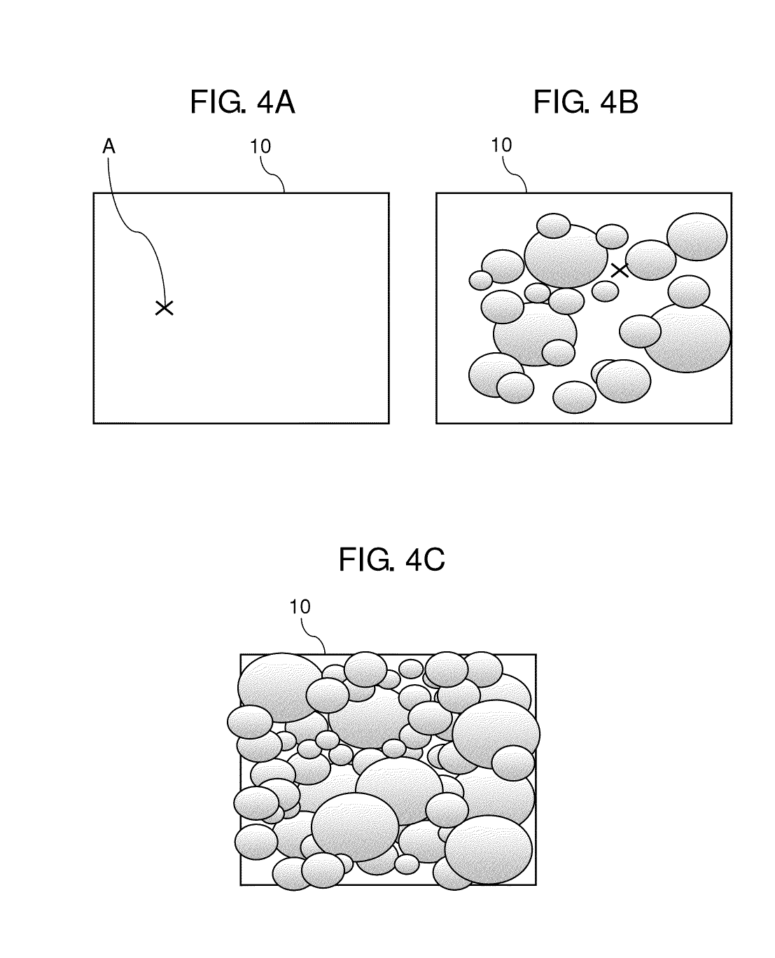

Referring to FIG. 4A, the third step is to randomly select a pixel position A in a top surface of the light diffuser 10. As will be described below, this third step is iteratively repeated.

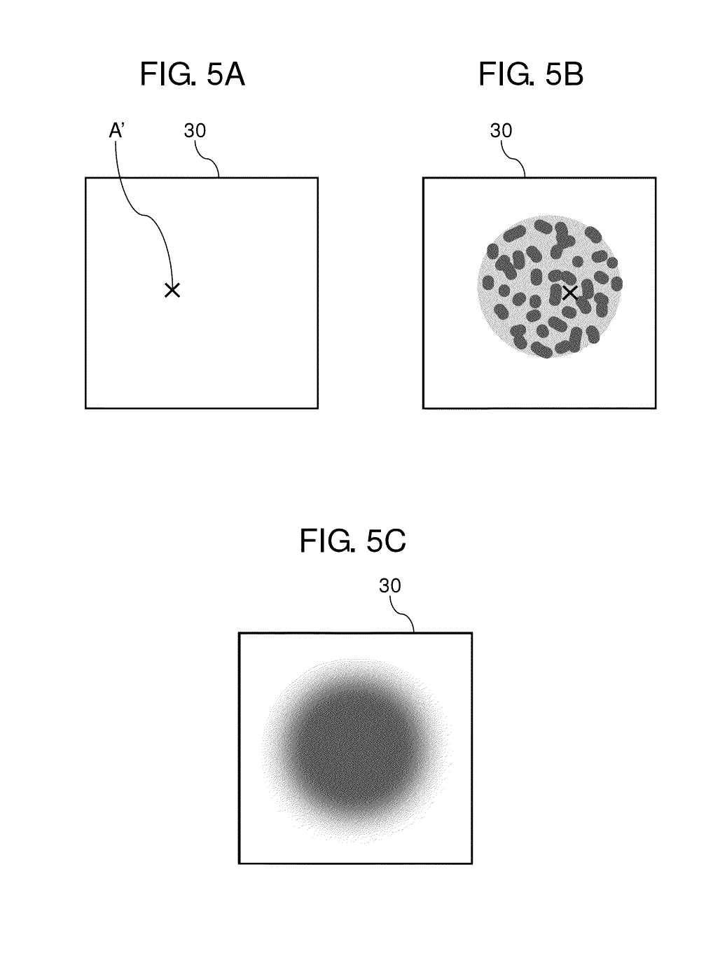

Referring to FIG. 5A, the fourth step is to select a first target position A′ in the target plane 30 in a random and non-uniform manner. In this context, random means that each individual time a target position is chosen in the target plane 30, the choice is not guided by any correlation between different target positions, and non-uniform means that at the end of the design process, all possible values of target position in the target plane 30 were not chosen the same number of times. For example, it may have been desired that the center position is to have been chosen 5 times less often than the perimeter. This process for selecting the target position A′ in the target plane 30 in a random and non-uniform manner can be accomplished by the use of a cumulative probability distribution such as, for example, a Box-Mueller algorithm. By using such a Box-Mueller method, it would be possible to design a random distribution that is weighted towards producing higher slope values more often. Similar to the third step, this fourth step is also iteratively repeated as will be described below.

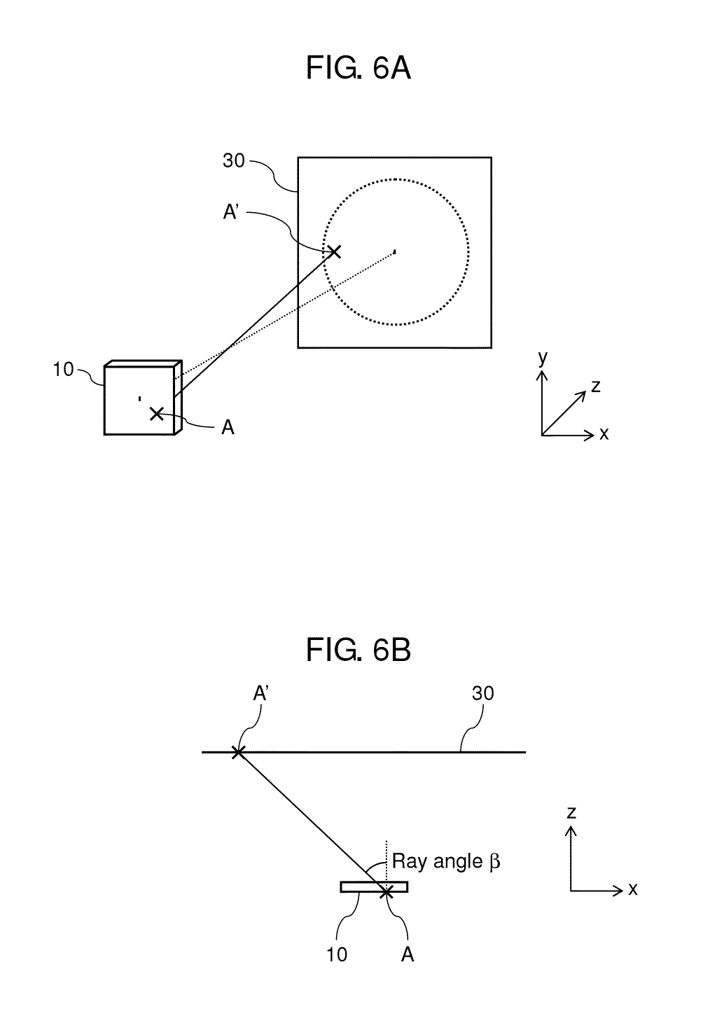

Referring to FIGS. 6A-6B, the fifth step is to compute the ray angle β of the line from the two points A and A′ selected in third and fourth steps, respectively. That is, the fifth step is to computer the ray angle β of a line extending from the randomly selected pixel position A in the top surface of the light diffuser 10 to the randomly and non-uniformly selected target position A′ in the target plane 30. As such, the light diffuser 10 according to the described embodiment is a point-to-point type of light diffuser (i.e., point A to point A′).

Next, the sixth step is to calculate a slope angle of a tilted plane element positioned at point A in the top surface of the diffuser 10 based upon the ray angle β computed in the fifth step and the incident/divergence angle of the inputted light vector 21 of the first step. One method to calculate such slope angle is by using equation (1) as follows:

$$slope = \frac{sin β - n \cdot sin ( - {θ}_{inc} )}{n \cdot cos ( - {θ}_{inc} ) - cos ( β )} \qquad ( 1 )$$

In Equation (1), n is the index of refraction of the transparent substrate, β is the ray angle computed in the fifth step, and δ_{inc} is the incident/divergence angle of the inputted light vector 21 from the first step.

The seventh step is to add a tilted plane micro-element having the calculated slope angle and having a random size within a desired limit (e.g., 20-40 μm) to the top surface of the diffuser 10. For example, the aforementioned Equation (1) is used to calculate and add the first tilted plane portion 12 having the tilt angle al as depicted in FIG. 1B.

Finally, the third through seventh steps described above are repeated until the top surface of the light diffuser 10 is completely filled with the tilted plane elements. That is, the selection of positions (i.e., similar to selection of position A) on the top surface of the diffuser 10 and the selection of target positions (i.e., similar to selection of position A′) on the target plane 30, as shown in FIGS. 4B and 5B, respectively, are iteratively repeated until the top surface of the light diffuser 10 is completely filled as shown in FIG. 4C to obtain the final desired target shape and intensity profile as shown in FIG. 5C. As stated earlier, the number of titled plane elements can be made to vary depending on various design criteria.

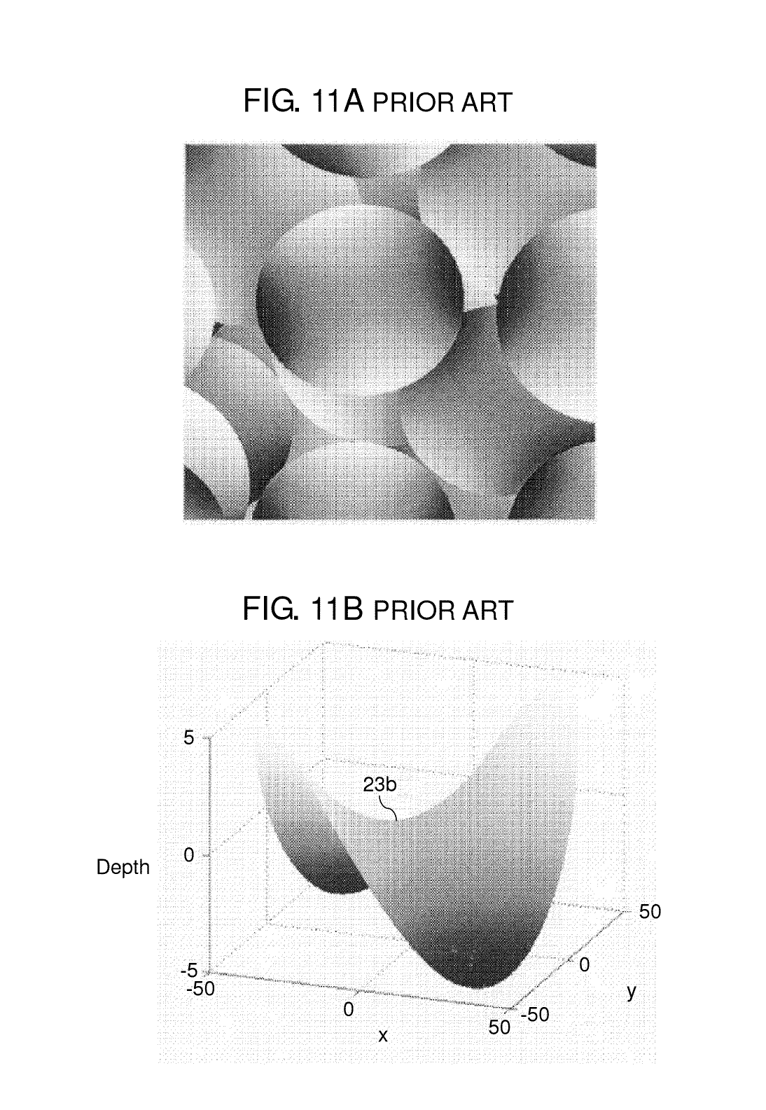

Next, a comparison is provided between a light diffuser according to the above-described exemplary embodiments and the prior art diffuser having the saddle-shaped elements depicted in FIGS. 11A-11B.

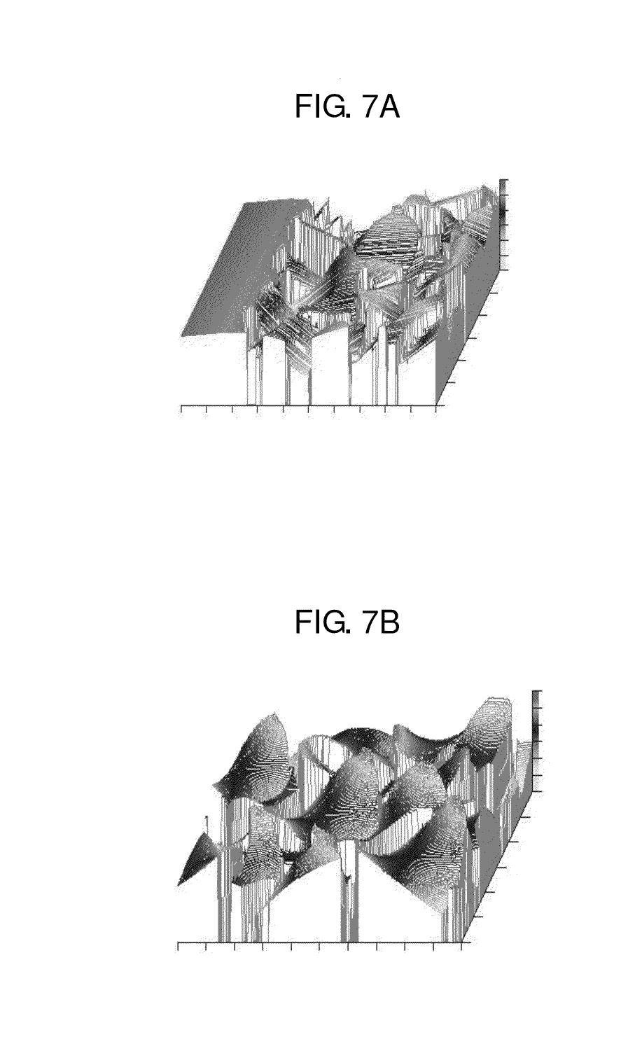

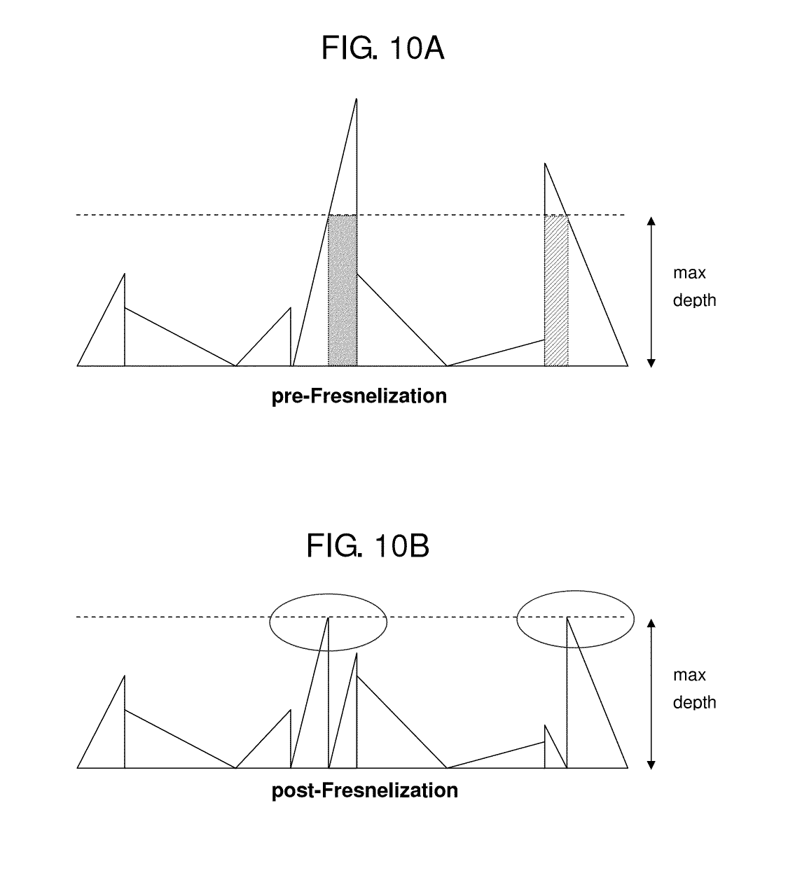

In order to provide a comparison of the surface profile of the light diffuser according to the above-described exemplary embodiments and the surface profile of the prior art diffuser depicted in FIGS. 11A-11B, a Zygo white-light interferometer was used to observe the surface profiles. The surface of a light diffuser with 5° half-angle output according to the above-described embodiments and the surface of a prior art diffuser depicted in FIGS. 10A-10B are shown in FIGS. 7A & 7B, respectively. The micro-elements contained on the light diffuser surfaces shown in both FIGS. 7A & 7B have similar diameters (tens of micrometers). Moreover, the light diffuser surfaces shown in both FIGS. 7A & 7B incorporate element overlap as a developmental feature. Generally, one important characteristic of light diffusers is the maximum feature depth (also known as “sag” in deference to the lens-like origin of these diffuser elements). While the light diffuser according to the exemplary embodiment shown in FIG. 7A has a preferable maximum depth of only 3 μm, the prior art diffuser depicted in FIG. 7B has maximum depth of at least 14 μm. In terms of fabrication, smaller sag almost universally enables faster and more inexpensive manufacturing techniques. Accordingly, with a maximum sag value several times smaller than the prior art diffuser shown in FIG. 7B, the light diffusers according to the present embodiments described above and as shown in FIG. 7A is clearly superior from at least a manufacturing standpoint.

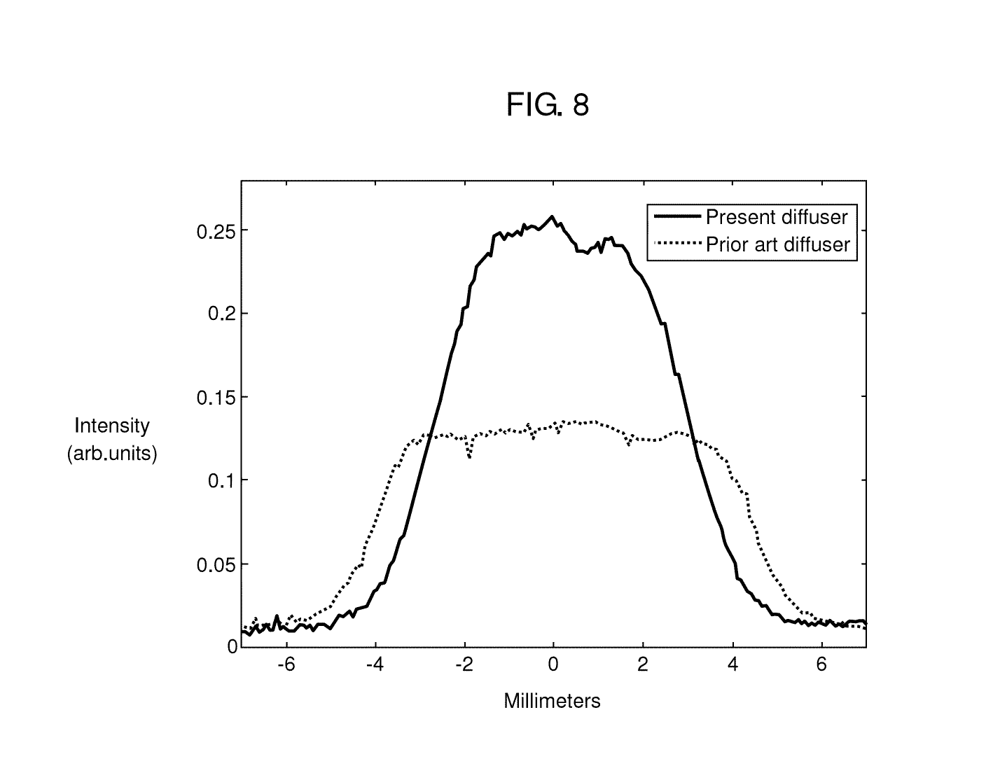

Next, characteristics used for assessing the quality of light diffusers are the steepness of transition between regions, uniformity and efficiency (i.e., the proportion of incoming light that makes it into the desired exit cone). FIG. 8 depicts a cross-section of output beams obtained by scanning a photodiode through the beam of a light diffuser according to the above-described embodiments and the prior art diffuser having the saddle shaped structures depicted in FIGS. 11A-11B. As visible from FIG. 8, the light diffuser according to the present embodiment accurately scatters at the design angle of 5°. However, the observed prior art diffuser exhibited a diffusing angle several degrees larger than specification. Moreover, as depicted in FIG. 8, the light diffuser according to the present embodiment is able to achieve an output beam shape which is nearly flat-top similar to the prior art diffuser, but which is able to achieve a much greater intensity than the observed prior art diffuser. Next, in order to obtain an accurate measure of the efficiency of the diffusers, the light output was imaged with a sensitive CCD camera and the pixel intensities were summed A measurement was carried out using an Apogee CCD camera with a very large sensor size of nearly 40×40 mm. Such a large sensor is necessary to capture all of the light within the scattering cone at a reasonable distance (e.g., 50-100 mm from the diffuser). The light diffuser according to the above-described embodiment achieved a total scattering efficiency of 0.84 and the observed prior art diffuser achieved a total scattering efficiency of 0.89. Thus, the light diffuser of the present embodiment is able to maintain a high level of light scattering efficiency (i.e., within 5% of the prior art diffuser) while providing the superior characteristics described earlier which are not possible to achieve using the prior art diffuser.

Described next is a method for manufacturing the light diffuser according to the embodiments described above. The exemplary technique used to manufacture the refractive light diffuser is grayscale lithography. In standard optical lithography, each resolvable element on the photosensitive resist may only exist in one of two states: exposed or unexposed. Therefore, all standard lithography patterns are binary. Alternatively, grayscale lithography is a form of optical lithography that can produce patterns with up to 8 bits of depth resolution. The exemplary grayscale system used according to the production of the diffuser of the present embodiments is a blue-laser writer and a precision stage motion is used to carefully control exposure levels.

Several modifications are preferably made to the pattern before it is suitable for grayscale production. For example, the depth of the features in a photosensitive resist according to the grayscale technique is limited so that such depth preferably does not exceed a sag value of 3 μm. To accommodate this limitation, the patterns can be “Fresnelized”. The term “Fresnelized” evokes the well-known Fresnel lens concept wherein excess material is removed during the design process and only the surfaces where active optical scattering occurs remain. For example, the hatched portions of elements depicted in FIG. 10A (pre-Fresnelization) are removed during the design process so that such elements do not exceed a desired maximum depth as depicted in FIG. 10B (post-Fresnelization). Using the Fresnelization technique, we are able to employ the high slope angles needed for the diffuser design while staying under the preferable 3 μm sag value limitation.

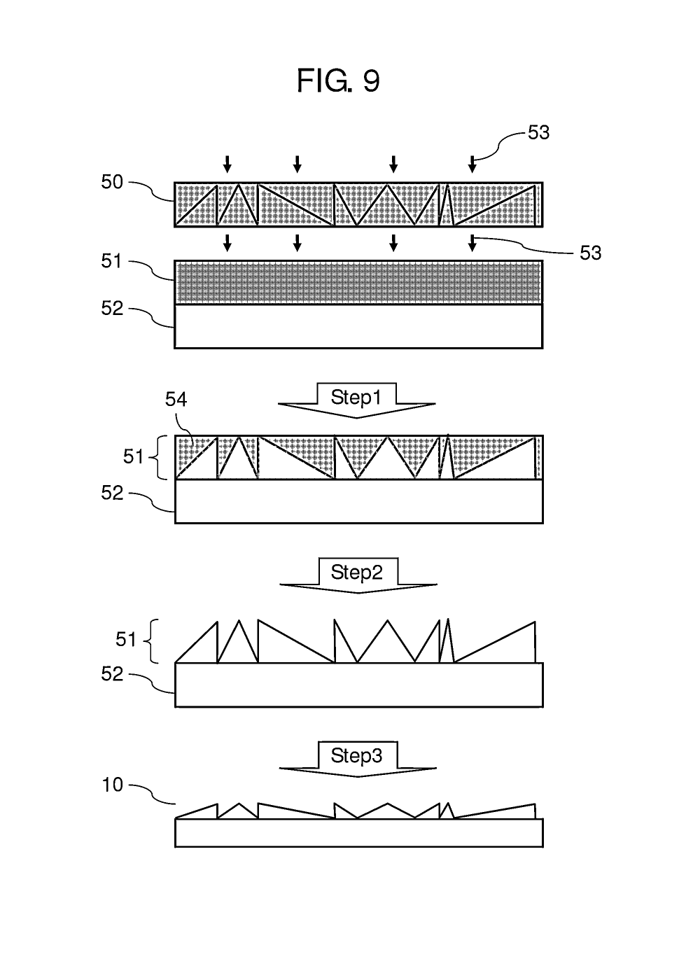

Referring to FIG. 9, the exemplary method for manufacturing a light diffuser 10 using a grayscale photo mask 50 configured according to the aforementioned design method is described. In Step 1, a photo resist 51 is provided on a top surface of a transparent substrate 52, and light 53 is exposed onto, and passes through, the grayscale photo mask 50 using a mask aligner or stepper which, in turn, transfers the grayscale structure from the grayscale photo mask 50 into the photo resist 51. Subsequently in Step 2, exposed portions 54 of the photo resist 51 are removed such that unexposed portions of the photo resist 51 remain. In step 3, etching is performed using any appropriate etching method such as, for example, a dry etching method including RIE (Reactive Ion etching) or wet etching using a suitable etchant solution or other method such as ion beam milling to thereby produce the final grayscale element 10.

Although the preferred embodiments have been described and disclosed for illustrative purposes, those skilled in the art will appreciate that various modifications, additions and substitutions are possible, without departing from the scope and spirit set forth in the accompanying claims.

What is claimed is:

1. A light diffuser comprising:
a transparent substrate having a top surface and a bottom surface;
the bottom surface of the transparent substrate having a substantially flat shape;
the top surface of the transparent substrate having formed thereon a plurality of tilted plane portions, the plurality of tilted plane portions including a first tilted plane portion and a second tilted plane portion;
the first tilted plane portion being tilted in a first direction with a first tilt angle with respect to the bottom surface of the transparent substrate;
the second titled plane portion being tilted in a second direction with a second tilt angle with respect to the bottom surface of the transparent substrate; and
the first direction of the first tilted plane portion being different from the second direction of the second tilted plane portion.

2. The light diffuser according to claim 1, wherein:
the first tilt angle of the first tilted plane portion being different from the second tilt angle of the second tilted plane portion.

3. The light diffuser according to claim 2, wherein:
the plurality of tilted plane portions including the first tilted plane portion and the second tilted plane portion have a circular shape.

4. The light diffuser according to claim 3, wherein:
the plurality of tilted plane portions including the first tilted plane portion and the second tilted plane portion are randomly positioned on the top surface of the substrate.

5. The light diffuser according to claim 2, wherein:
the plurality of tilted plane portions including the first tilted plane portion and the second tilted plane portion have a shape selected from a group including: circular shape, oval shape, rectangular shape, pyramidal shape, trapezoidal shape and hexagonal shape.

6. A refractive light diffuser for outputting a predetermined beam shape having a predetermined intensity onto a target plane, the refractive light diffuser comprising:
a transparent substrate having a first surface and a second surface;
the first surface of the transparent substrate having a substantially flat shape configured to receive light emitted from a light source;
the second surface of the transparent substrate being configured to output the predetermined beam shape having the predetermined intensity onto the target plane;
a plurality of circular shaped micro-elements formed on the second surface of the transparent substrate, the circular shaped micro-elements each having a tilted plane portion; and
the tilted plane portions of the plurality of circular shaped micro-elements having different sizes and different angles of tilt.

7. The refractive light diffuser according to claim 6, wherein:
the plurality of circular-shaped micro-elements are randomly arranged on the second surface of the transparent substrate in an overlapping manner.

8. The refractive light diffuser according to claim 6, wherein:
the predetermined beam shape outputted by the refractive light diffuser is one selected from a group including: a circular shape, a square shape, a cross shape, a star shape and a donut shape.

9. The refractive light diffuser according to claim 6, wherein:
the plurality of circular shaped micro-elements have a diameter within a range of 20-100 μm.

10. The refractive light diffuser according to claim 6, wherein:
the refractive light diffuser has a sag value no greater than 3 μm which is obtained by Fresnelization.

11. The refractive light diffuser according to claim 6, wherein:
the predetermined beam shape outputted by the refractive light diffuser has an intensity which varies at different positions within the predetermined beam shape.

12. A method of manufacturing a light diffuser comprising:
forming a photosensitive resist on a top surface of a transparent substrate;
exposing the photosensitive resist to an exposing light passing through a grayscale mask;
forming a resist pattern by removing a part of the photosensitive resist; and
forming a top surface of the transparent substrate by etching the resist pattern and the transparent substrate;
wherein the top surface of the transparent substrate has formed thereon a plurality of tilted plane portions, the plurality of tilted plane portions including a first tilted plane portion and a second tilted plane portion;
the first tilted plane portion being tilted in a first direction with a first tilt angle with respect to a bottom surface of the transparent substrate;
the second titled plane portion being titled in a second direction with a second tilt angle with respect to the bottom surface of the transparent substrate; and
the first direction of the first tilted plane portion being different from the second direction of the second tilted plane portion.

13. The method of manufacturing the light diffuser according to claim 12, wherein:
the plurality of tilted plane portions including the first tilted plane portion and the second tilted plane portion have a shape selected from a group including: circular shape, oval shape, rectangular shape, pyramidal shape, trapezoidal shape and hexagonal shape.

14. The method of manufacturing the light diffuser according to claim 12, wherein:
the plurality of tilted plane portions including the first tilted plane portion and the second tilted plane portion are randomly arranged on the top surface of the transparent substrate in an overlapping manner.

15. The method of manufacturing the light diffuser according to claim 12, wherein:
the plurality of tilted plane portions are circular shaped having a diameter within a range of 20-100 μm.

16. The method of manufacturing the light diffuser according to claim 12, wherein:
the light diffuser has a sag value no greater than 3 μm which is obtained by Fresnelization.
